(19) United States
(12) Patent Application Publication
(10) Pub. No.: US 2017/0317334 A1
(43) Pub. Date: Nov. 2, 2017

(54) CATHODE PLATE FOR ALL-SOLID BATTERY, AND ALL-SOLID BATTERY

(71) Applicant: NGK INSULATORS, LTD., Nagoya-Shi (JP)

(72) Inventors: Yukinobu YURA, Nagoya-Shi (JP); Naoto OHIRA, Nagoya-Shi (JP); Nobuyuki KOBAYASHI, Nagoya-Shi (JP)

(73) Assignee: NGK INSULATORS, LTD., Nagoya-Shi (JP)

(21) Appl. No.: 15/655,046

(22) Filed: Jul. 20, 2017

Related U.S. Application Data
(63) Continuation of application No. PCT/JP2016/051267, filed on Jan. 18, 2016.

(30) Foreign Application Priority Data
Jan. 23, 2015 (JP) 2015-010842
Feb. 20, 2015 (JP) 2015-031192

(51) Int. Cl. H01M 4/04; H01M 4/52; H01M 4/66; H01M 2/02; H01M 4/1391; H01M 4/525; H01M 4/131; H01M 4/505

(52) U.S. Cl. CPC H01M 4/0407; H01M 4/131; H01M 4/52; H01M 4/505; H01M 2/0287; H01M 4/1391; H01M 4/525; H01M 4/664; H01M 4/667; H01M 2004/021

(57) ABSTRACT

A cathode plate of an all-solid battery configures a cathode of an all-solid battery including a solid electrolyte layer composed of an oxide-based ceramic material. A surface roughness on a solid electrolyte layer-side surface of the cathode plate on which the solid electrolyte layer is formed falls within a range of 0.1 micrometer to 0.7 micrometer.

### CROSS-REFERENCE TO RELATED APPLICATIONS

This application claims priority under 35 U.S.C. §119 to Japanese Patent Application No. 2015-010842 filed on Jan. 23, 2015, and Japanese Patent Application No. 2015-031192 filed on Feb. 20, 2015. The entire disclosure of Japanese Patent Application No. 2015-010842 and Japanese Patent Application No. 2015-031192 is hereby incorporated herein by reference.

### BACKGROUND

### Technical Field

The present invention relates to a cathode plate for an all-solid battery that configures a cathode of an all-solid battery.

### Background Art

Typically, lithium oxide has been used for a cathode plate (cathode active substance) that configures a cathode of an all-solid battery, and an example of this type of cathode plate is disclosed in PCT Laid Open Application 2010/074304. This cathode plate is an oriented sintered plate formed by firing a green sheet containing Co₃O₄ and an orientation promotion agent, and then introducing lithium ions into the fired body. The all-solid battery (all-solid lithium battery) is formed as a result of forming a solid electrolyte layer on a surface of the oriented sintered plate.

### SUMMARY

The present inventors gained the insight during the development stage of this type of all-solid battery that a surface unevenness structure (state of surface unevenness) on the solid electrolyte layer-side surface of the cathode plate on which the solid electrolyte layer is formed has an effect on battery performance. To describe this insight in more detail, when the surface unevenness of the cathode plate is excessively large, there is a tendency for localized concentration of electrical fields in the uneven portion during charge-discharge cycle testing. For example, the cathode plate of the all-solid battery disclosed in PCT Laid Open Application 2010/074304 has a surface roughness (surface roughness is one indication of a surface unevenness structure) of a level that exceeds 0.8 micrometer, and is associated with a tendency to produce localized concentration of electrical fields in that uneven portion. On the other hand, when the surface unevenness of the cathode plate is excessively small, in the event of a volume expansion or volume shrinkage during charge and discharge, there is a tendency for the solid electrolyte layer to peel from the cathode plate, and as a result, desired cycle characteristics are no longer obtained in the all-solid battery. The present inventors conducted diligent investigation into the effect of the constituent elements of an all-solid battery on battery performance of the all-solid battery (cycle characteristics, rate characteristics, or the like) and have gained the insight that it is possible to suppress localized electrical field concentration as described above and prevent peeling as described above at least by modifying the surface unevenness structure of the cathode plate, and as a result, have enabled the construction of an all-solid battery that exhibits superior battery performance.

In light of the circumstances described above, an object of the present invention is to provide an all-solid battery that exhibits superior battery performance.

### Solution to Problem

In order to achieve the above object, the all-solid battery cathode plate according to the present invention (referred to below simply as “cathode plate”) configures a cathode of an all-solid battery that includes a solid electrolyte layer composed of an oxide-based ceramic material, and exhibits a surface roughness on the solid electrolyte layer-side surface (covered surface) of the cathode plate on which the solid electrolyte layer is formed in a range of 0.1 micrometer to 0.7 micrometer. As a result of repeated evaluation testing on the all-solid battery performed by the present inventors, the insight was gained that battery performance can be maintained at a high level when the surface roughness of at least the cathode plate is adjusted to a range of 0.1 micrometer to 0.7 micrometer, when compared to a configuration in which there is no such adjustment. That is to say, when the surface roughness of the cathode plate falls below 0.1 micrometer, cycle performance is adversely affected and there is a tendency for the solid electrolyte layer to peel from the cathode plate as a result of volume expansion or volume shrinkage during charge and discharge. Furthermore, when the surface roughness of the cathode plate exceeds 0.7 micrometer, there is a tendency for localized concentration of electrical fields in the uneven portions during charge-discharge cycle testing. Therefore construction of an all-solid battery that exhibits particularly superior battery performance has been enabled by adjustment of the surface roughness to a range of 0.1 micrometer to 0.7 micrometer.

The solid electrolyte layer formed on the solid electrolyte layer-side surface of the above configuration preferably has a thickness in a range from 1.0 micrometer to 6.0 micrometer. In this manner, localized short circuiting can be reduced and peeling of the solid electrolyte layer can be suppressed since it is possible to adjust the film stress in response to film formation conditions of the solid electrolyte layer. Therefore, construction of an all-solid battery that in particular is superior both in relation to cycle characteristics and rate characteristics is enabled by forming a solid electrolyte layer that has a thickness adjusted to a range of 1.0 micrometer to 6.0 micrometer, to the cathode plate having a surface roughness adjusted to a range from 0.1 micrometer to 0.7 micrometer.

The solid electrolyte layer formed on the solid electrolyte layer-side surface of the above configuration preferably has a thickness in a range from 0.5 micrometer to 3.0 micrometer. When the thickness of the solid electrolyte layer is adjusted to a range from 0.5 micrometer to 3.0 micrometer, in comparison to a configuration in which there is no such adjustment, a higher level of battery performance of the all-solid battery can be maintained. That is to say, a solid electrolyte layer thickness of at least 0.5 micrometer suppresses the occurrence of defects in the solid electrolyte layer. Furthermore, rate characteristics can be enhanced due to the fact that a solid electrolyte layer thickness of no more than 3.0 micrometer suppresses peeling of the solid electrolyte layer and suppresses an increase in the resistance of the solid electrolyte layer itself. Therefore construction of an all-solid battery that, in particular, is superior both in relation to cycle characteristics and rate characteristics is enabled by forming a solid electrolyte layer that has a thickness adjusted to a range of 0.5 micrometer to 3.0 micrometer to a cathode plate that has a surface roughness adjusted to a range from 0.1 micrometer to 0.7 micrometer.

In the all-solid battery cathode plate having the above configuration, the cathode plate preferably has a thickness in a range from 10 micrometer to 60 micrometer. In this manner, a cathode plate can be provided that exhibits a thickness that is adapted to the all-solid battery.

An all-solid battery cathode plate having the above configuration preferably includes lithium cobalt oxide, and the solid electrolyte layer is composed of a lithium phosphorus oxynitride-based ceramic material that is an oxide-based ceramic material. In this manner, a cathode plate can be provided that is adapted to the all-solid lithium battery.

### Advantageous Effects of Invention

As described above, the present invention provides an all-solid battery exhibiting superior battery performance by adjusting the surface unevenness structure of at least the solid electrolyte layer-side surface of a cathode plate on which the solid electrolyte layer is formed.

### BRIEF DESCRIPTION OF DRAWINGS

FIG. 1 illustrates the laminate structure of an all-solid lithium battery 100 according to the present invention.

FIG. 2 is a flowchart illustrating an example of a method of manufacturing a cathode plate 106 that configures the all-solid lithium battery 100 in FIG. 1.

### DETAILED DESCRIPTION OF EMBODIMENTS

The embodiments of the present invention will be described below making reference to the figures.

### All-Solid Lithium Battery

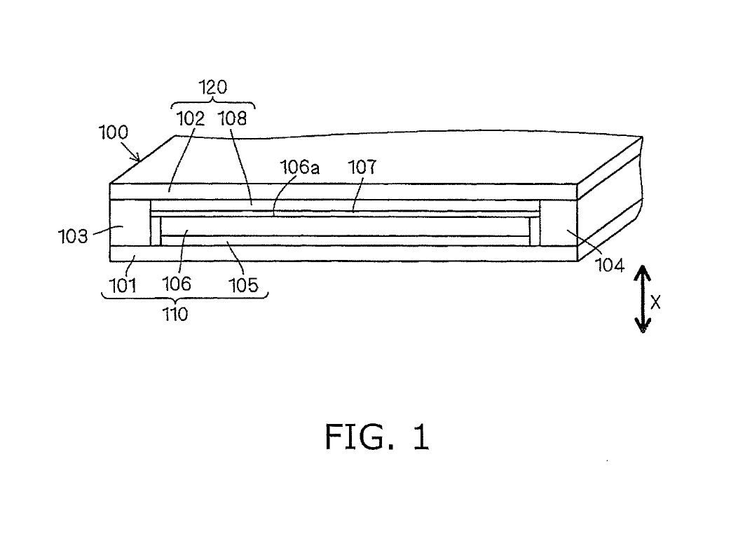

As illustrated in FIG. 1, a chip-type all-solid lithium battery configured as a plate piece (referred to below simply as “all-solid battery”) 100 is a secondary battery (chargeable battery) that can be repeatedly used by charging and discharging. The all-solid battery 100 includes a cathode-side current collector 101, an anode-side current collector 102, cladding 103, 104, a current collector connection layer 105, a cathode plate 106, a solid electrolyte layer 107 and an anode layer 108. The plate thickness direction X of the all-solid battery 100 in order from the cathode side is configured by stacking of the cathode-side current collector 101, the current collector connection layer 105, the cathode plate 106, the solid electrolyte layer 107, the anode layer 108, and the anode-side current collector 102. The end portion in the plate width direction of the all-solid battery 100 is sealed by the cladding 103, 104. The cathode 110 is configured by the cathode-side current collector 101, the current collector connection layer 105, and the cathode plate 106. The anode 120 is configured by the anode-side current collector 102 and the anode layer 108. The all-solid lithium battery 100 corresponds to the “all-solid battery” of the present invention.

### Cathode Plate

The cathode plate 106 is mainly comprised of LiCoO₂ that exhibits a lamellar rock-salt structure, and in particular is configured as a lithium cobalt oxide oriented sintered plate in which the (104) plane in relation to a Miller index hkl of the plurality of crystalline surface is oriented parallel to the plate surface. The cathode plate 106 may also include a further trace-amount addition of one or more of the elements including Mg, Al, Si, Ca, Ti, V, Cr, Fe, Cu, Zn, Ga, Ge, Sr, Y, Zr, Nb, Mo, Ag, Sn, Sb, Te, Ba, Bi, or the like (referred to below as “added elements”) in a configuration corresponding to doping or a similar configuration (for example, a partial solid solution or segregation into the surface layer of the crystal particles). The surface of the cathode plate 106 may be covered using a compound (referred to below as “added element compound”) including at least one of the above added elements selected from the group consisting of Ti, Al, and Zr, W, Mg, Nb and Ba. In this context, the cathode plate 106 corresponds to the “all-solid battery cathode plate” of the present invention.

The cathode plate 106 may be configured from other materials in addition to LiCoO₂. Such other materials for example include use of a material having a basic composition expressed by Liₚ (Niₓ, Co_{y}, Mn_{z})O₂ (wherein, 0.9≦p≦1.3, 0<x<0.8, 0<y<1, 0≦z≦0.7, x+y+z=1 (preferably, 0.95≦p≦1.1, 0.1≦x<0.7, 0.1≦y<0.9, 0≦z≦0.6, x+y+z=1)) or Liₚ (Niₓ, Co_{y}, Al_{z})O₂ (wherein, 0.9≦p≦1.3, 0.6<x<0.9, 0.1<y≦0.3, 0≦z≦0.2, x+y+z=1 (preferably, 0.95≦p≦1.1, 0.7≦x<0.9, 0.1<y≦0.25, 0≦z≦0.1, x+y+z=1)). The basic composition above is a composition that includes nickel and cobalt of lithium transition metal oxides that exhibit a lamellar rock-salt structure. Typical examples of materials that have the above composition include lithium nickel cobalt oxides, lithium cobalt nickel manganese oxides, and lithium nickel cobalt aluminum oxides, or the like.

### Solid Electrolyte Layer

The solid electrolyte layer 107 is preferably composed of a lithium phosphorus oxynitride (LiPON)-based ceramic material that is an oxide-based ceramic material. Although there is no particular limitation in relation to the thickness of the solid electrolyte layer 107, the thickness may be configured as 0.1 micrometer to 10 micrometer. The thickness of the solid electrolyte layer 107 is preferably 1.0 micrometer to 6.0 micrometer. In this manner, localized short circuiting can be reduced and peeling of the solid electrolyte layer 107 can be suppressed since it is possible to adjust the film stress in response to film formation conditions for the solid electrolyte layer 107. The thickness of the solid electrolyte layer 107 is preferably in a range from 0.5 micrometer to 3.0 micrometer. In this manner, defects, peeling and resistance in the solid electrolyte layer 107 can be suppressed and thereby enhance rate characteristics. A sputtering method is preferred as a film formation method for formation of a battery by attachment of the solid electrolyte layer 107 composed of the above ceramic materials to the solid electrolyte layer-side surface 106a of the cathode plate 106. Typically, the thickness of the solid electrolyte layer 107 can be adjusted by controlling the film formation conditions (for example, film formation time) with the sputtering method. The cathode plate 106 does not exhibit a tendency for malfunction of battery performance even when configured as a battery by use of a sputtering method to form a solid electrolyte layer configured from a surface layer of LiPON. LiPON is a compound group expressed as the composition Li_{2.9}PO_{3.3}N_{0.46}, and for example, is a compound group expressed by LiₐPO_{b}N_{c} (wherein, a is 2 to 4, b is 3 to 5, and c is 0.1 to 0.9). Therefore, formation of the LiPON-based solid electrolyte layer by sputtering may be performed with reference to known conditions by use a lithium phosphate sintered body target as a source of Li, P and O and introducing N₂ in the form of gas as an N source. Although there is no limitation in relation to the sputtering method, an RF magnetron configuration is preferred. Furthermore, in addition to a sputtering method, the film formation method may be configured as an MOCVD method, sol gel method, aerosol deposition method, screen printing method, or the like. The solid electrolyte layer 107 in this configuration corresponds to the “solid electrolyte layer” of the present invention.

In addition to a LiPON-based ceramic material, the solid electrolyte layer 107 may be configured to the other oxide-based ceramic. Other oxide-based ceramic materials include at least one type selected from the group consisting of a garnet-based ceramic material, nitride-based ceramic material, perovskite-based ceramic material, phosphate-based ceramic material, and zeolite-based ceramic material. An example of the garnet-based ceramic also includes use of an Li—La—Zr—O-based material (more specifically, Li₇La₃Zr₂O₁₂ or the like) and an Li—La—Ta—O-based material. An example of a perovskite ceramic material includes an Li—La—Ti—O-based material (more specifically, LiLa₁₋ₓTiₓO₃ (0.04≦x≦0.14) or the like). An examples of a phosphate-based ceramic material includes Li—Al—Ti—P—O, Li—Al—Ge—P—O, and Li—Al—Ti—Si—P—O(more specifically, Li_{1+x+y}AlₓTi₂₋ₓSi_{y}P_{3-y}O₁₂ (0≦x≦0.4, 0<y≦0.6) or the like).

### Method of Manufacturing Cathode Plate

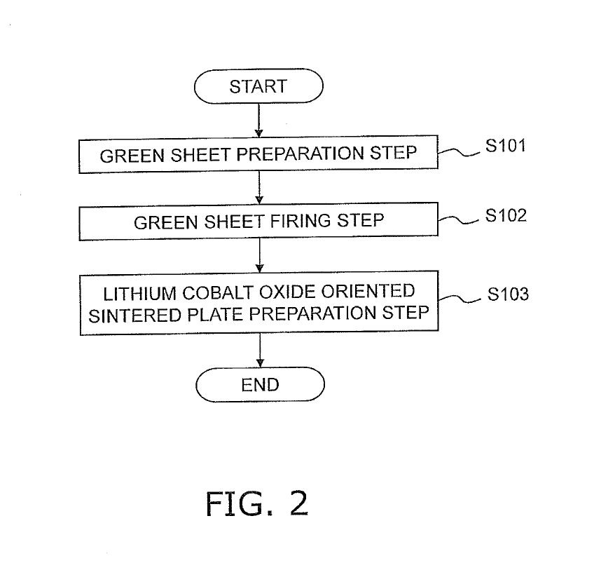

As illustrated in FIG. 2, the method of manufacture for manufacturing the cathode plate 106 that has the above configuration includes a green sheet preparation step S101, a green sheet firing step S102, and a lithium cobalt oxide oriented sintered plate preparation step S103. Before or after each of these three steps, it is possible to add one or a plurality of other steps. These other steps preferably include the inclusion of a step of adjusting a surface roughness of the surface of the fired plate obtained in the green sheet firing step S102, or a step of adjusting a surface roughness of the surface of the sintered plate obtained in the lithium cobalt oxide oriented sintered plate preparation step S103. Those steps may include use of polishing treatment to polish the surface of the fired plate or sintered plate, a thermal treatment configured to further fire the fired plate or sintered plate after the polishing treatment, a chemical treatment using a corrosive effect of a chemical or the like such as those used in etching, a thermal treatment in which an additive such as lithium, titanium, magnesium or the like is added, and a thermal treatment in which lithium cobalt oxide or cobalt oxide particles are coated onto the lithium-cobalt-oxide or cobalt-oxide sintered plate, or the like. In the present specification, the sheet-shaped fired body obtained in the green sheet firing step S102, that is to say, the fired body prior to introduction of lithium is herein termed the “fired plate”, and the sheet-shaped sintered body obtained in the lithium cobalt oxide oriented sintered plate preparation step S103, that is to say, the sintered body after introduction of lithium is herein termed “sintered plate.” The sheet-shaped fired body prior to introduction of lithium and the sheet-shaped fired body after introduction of lithium may be herein termed “fired plate.”

### Green Sheet Preparation Step

The green sheet preparation step is a step for preparation an unfired sheet-shaped green sheet including a Co source (typically Co₃O₄ (tricobalt tetroxide) particles and a bismuth oxide (typically, Bi₂O₃ particles) as an orientation promotion agent. The step enables formation of a green sheet by firing a starting material that typically includes Co₃O₄ particles and Bi₂O₃ particles in a sheet shape. Although there is no particular limitation on the added amount of Bi₂O₃ particles, it is preferably in the range of 0.1 wt % to 30 wt %, more preferably 1 wt % to 20 wt %, and still more preferably 3 to 10 wt % relative to the total amount of Co₃O₄ particles and Bi₂O₃ particles. The particle diameter of a standard volume D50 of Co₃O₄ particles is preferably 0.1 micrometer to 0.6 micrometer. The particle diameter of a standard volume D50 of Bi₂O₃ particles is preferably 0.1 micrometer to 1.0 micrometer, and more preferably 0.2 to 0.5 micrometer. The thickness of the green sheet is no more than 100 micrometer, preferably 1 micrometer to 80 micrometer, and still more preferably 5 micrometer to 65 micrometer.

The green sheet may be configured only using Co₃O₄ particles as a Co source, or may include CoO particles and/or Co(OH)₂ particles in addition to a portion or the whole of the Co₃O₄ particles. That is to say, in the present invention, as long as the Co source includes at least Co, there is no limitation to use only of Co₃O₄. Even when the green sheet contains CoO particles and/or Co(OH)₂ particles, the green sheet can be fired in the green sheet firing step S102 to thereby prepare a Co₃O₄ oriented fired plate or a CoO-based fired intermediate in which the (h00) plane of the Miller index hkl is oriented parallel to the sheet surface. As a result, it is possible to manufacture a lithium cobalt oxide oriented sintered plate exhibiting the same properties in the following lithium cobalt oxide oriented sintered plate preparation step S103 as a green sheet that only uses Co₃O₄ particles as the Co source.

Preparation of the green sheet may use (i) a doctor blade method that employs a slurry that contains starting material particles, (ii) a method that employs a drum drier in which a slurry that contains a starting material is coated onto a heated drum and the dried slurry is removed with a scraper, and (iii) an extrusion molding method using raw earth containing starting material particles. A particularly preferred sheet forming method is the doctor blade method. When using the doctor blade method, a slurry is coated onto a flexible plate (for example, an organic polymer plate such as PET film or the like), the coated slurry is dried and hardened to form a molded body, and the molded body is peeled from the plate to thereby complete preparation of the green sheet. When preparing the slurry or raw earth prior to molding, inorganic particles may be dispersed in a dispersion medium and a binder or plasticizer may be suitably added. Furthermore, the slurry is preferably prepared to exhibit a viscosity of 500 to 4000 cP and is preferably degassed under reduced pressure.

### Green Sheet Firing Step

The green sheet firing step is a step in which the green sheet obtained in the green sheet preparation step is fired at a predetermined firing temperature (900 to 1350 degrees C.). This step enables preparation of a Co₃O₄ oriented fired plate that exhibits an orientation in which the (h00) plane (h being an arbitrary integer, for example, h=2) of the Miller index hkl is parallel to the sheet surface.

When the green sheet contains Co₃O₄ particles as the Co source, the Co₃O₄ particles before firing exhibit an isotropic configuration, and although the green sheet does not initially exhibit oriented characteristics (is non-oriented), orientation is produced in the step of grain growth with phase transformation of the Co₃O₄ particles into CoO by temperature increases during firing (referred to below as “CoO orientation grain growth”). At this time, there is a temporary transition through an fired intermediate in which the Co₃O₄ particles are converted into CoO that exhibits an orientation in which the (h00) plane is parallel to the sheet surface. That is to say, at 900 degrees C. or more (for example a temperature of at least 920 degrees C.), the Co oxide undergoes a phase transformation from a spinel structure expressed by Co₃O₄ at ambient temperature to a lamellar rock-salt structure expressed by CoO. Firing has the result that Co₃O₄ is reduced and undergoes a phase transformation to CoO to thereby increase the density of the sheet. In addition, CoO is oxidized to Co₃O₄ in a process in which the temperature of the fired intermediate falls during the fall in temperature after firing. At that time, an oriented fired plate is formed that is composed of numerous Co₃O₄ particles that exhibit an orientation in which the (h00) plane is parallel to the sheet surface due to the fact that the CoO orientation direction is imparted to Co₃O₄. In particular, CoO orientation grain growth is promoted in the presence of bismuth oxides (typically, Bi₂O₃). During firing, the bismuth is removed by vaporization from the sheet.

During the green sheet firing step, the firing temperature of the green sheet is a temperature in the range of 900 to 1350 degrees C., preferably a temperature in the range of 1000 to 1300 degrees C., and still more preferably a temperature in the range of 1050 to 1300 degrees C. The time for firing of the green sheet at the above firing temperature is preferably a time within the range of 1 to 20 hours, and more preferably a time within the range of 2 to 10 hours. The temperature decrease rate after firing of the green sheet at the above firing temperature is preferably a rate in the range of 10 to 200 degrees C./hour, and more preferably a rate in the range of 20 to 100 degrees C./hour.

CoO orientation grain growth imparts a green sheet thickness of no more than 100 micrometer. That is to say, a green sheet having at thickness of no more than 100 micrometer has an extremely small amount of material in the thickness direction compared to the sheet in-plane direction (direction orthogonal to the thickness direction). As a result, grain growth occurs in a random direction during an initial step in which a plurality of particles are present in the thickness direction. On the other hand, as grain growth progresses, the material present in the thickness direction is consumed and therefore the grain growth direction is limited to a two dimensional direction in the sheet surface (referred to below as the surface direction). In this manner, progression of grain growth in the surface direction can be ensured. In particular, progression of grain growth in the surface direction can be ensured by formation of the thinnest possible green sheet (for example, no more than several micrometer), or by progression of grain growth to the greatest degree possible even when the green sheet is relative thick (for example, about 20 micrometer). In either case, during firing, only particles that retain crystal planes having the lowest surface energy in the surface of the green sheet will undergo selective grain growth in a flat configuration (plate shape) in relation to the surface direction. As a result, firing of the green sheet obtains a firing intermediate that exhibits a large aspect ratio and in which the CoO plate-shaped crystal particles that have an orientation of the (h00) plane in parallel to the plate surface of the particles are oriented so that the (h00) plane is parallel to the sheet surface. Thereafter, CoO is oxidized to Co₃O₄ in the step in which the temperature of the fired intermediate falls, and the formation of the oriented fired plate in which numerous Co₃O₄ particles are oriented so that the (h00) plane is parallel to the sheet surface has been described above.

The Co₃O₄ oriented fired plate formed from numerous Co₃O₄ particles is an independent plate-shaped sheet. In this context, “independent” sheet means a sheet that can be handled separately and independently from other supporting bodies after firing. That is to say, an “independent” sheet does not include a configuration that is attached to other support bodies (a substrate, or the like) as a result of firing or that is integrally formed with such support bodies (inseparable or difficult to separate). In this manner, an independent oriented fired plate is obtained in which numerous particles are bound with an orientation so that the (h00) plane is parallel to the plate surface of the particle. The independent plate is configured as a dense Co₃O₄ oriented fired plate in which numerous Co₃O₄ particles as described above are bound without gaps.

### Lithium Cobalt Oxide Oriented Sintered Plate Preparation Step

The step of preparing the lithium cobalt oxide oriented sintered plate is a step of firing the Co₃O₄ oriented fired plate obtained in the green sheet firing step in a lithium atmosphere in the presence of a lithium source. This step enables the introduction of lithium (Li) into the Co₃O₄ oriented fired plate. The introduction of lithium is preferably performed by reacting a lithium compound with the Co₃O₄ oriented fired plate. The lithium compound being the source of lithium is typically (i) lithium hydroxide, (ii) various lithium salts such as lithium carbonate, lithium nitrate, lithium acetate, lithium chloride, lithium oxalate, lithium citrate, or the like, and (iii) various lithium alkoxides such as lithium methoxide, lithium ethoxide, or the like. It is particularly preferred to use lithium hydroxide or lithium carbonate as a source of lithium. The method of placing the Co₃O₄ oriented fired plate in the presence of a lithium source includes a method of depositing lithium starting material powder on the plate surface of the Co₃O₄ oriented fired plate, a method of coating a solution in which a lithium source is dissolved or a slurry containing a dispersion of a starting material powder onto the plate surface of the Co₃O₄ oriented fired plate by use of a sprayer, dispenser or the like, a method of disposing a green sheet containing an Li starting material powder on one or both surfaces of the Co₃O₄ oriented fired plate, and a method of arranging the Co₃O₄ oriented fired plate on a surface of a setter containing an Li compound followed by a sandwiching operation, or the like. The conditions during introduction of lithium, for example, the mixing ratio, the temperature increase rate, the heating temperature, heating time, atmosphere, or the like may be suitably set taking into account the melting point, decomposition temperature or reactivity or the like of the material used as the lithium source, and there is no particular limitation in this regard. For example, after coating and drying a predetermined amount of a slurry containing a dispersion of LiOH powder onto the Co₃O₄ oriented fired plate, lithium is introduced into the Co₃O₄ particles by heating. The heating temperature at this time is preferably 600 to 880 degrees C., and heating is preferably performed for 2 to 20 hours in this range. Furthermore, the amount of the lithium compound deposited onto the Co₃O₄ oriented fired plate is preferably at least 1.0 expressed as an Li/Co ratio, and more preferably 1.0 to 1.5. No problem will arise in the event of an excess of Li since the excess portion of Li can be removed by vaporization during heating. The flatness of the lithium cobalt oxide oriented sintered plate can be increased (for example, the degree of unevenness on the plate surface can be reduced to a small value) by firing in a configuration in which a weight is applied to the Co₃O₄ oriented fired plate. Oxygen required for synthesis can be supplied in a sufficient amount to the plate surface of the Co₃O₄ oriented fired plate by use of a porous setter or a setter having an opening provided therein (for example, a honeycomb shaped setter) in a weight application operation. There is an increase in the bulk of Li starting material deposited on a lithium cobalt oxide oriented sintered plate that is relative thick (for example, at least 30 micrometer), and synthesis failure may result as a result of a portion of the Li starting material dissolved during heating flowing away and not being used in the synthesis process. In this case, the step of deposition and thermal treatment of the Li starting material (that is to say, the step of introducing Li) should be repeated.

When a step is used to adjust the surface roughness of the Co₃O₄ oriented fired plate that is the precursor for the lithium cobalt oxide oriented sintered plate, it is preferred to polish the surface of the Co₃O₄ oriented fired plate before introducing lithium. In this configuration, surface roughness of the Co₃O₄ oriented fired plate can be suppressed by introducing lithium after the polishing operation.

The resulting lithium cobalt oxide oriented sintered plate (cathode plate 106 in FIG. 1) exhibits an orientation in which the (104) plane of LiCoO₂ is parallel to the plate surface. Therefore the (104) plane that is characterized by superior movement of lithium ions of the plurality of crystalline planes is oriented in parallel to the plate surface of the oriented sintered plate. As a result, when the oriented sintered plate is used as a cathode active substance to configure a battery, there is greater exposure (contact) of (104) plane to the electrolyte, and there is an extremely low exposure ratio of the (003) plane (plane not adapted for movement of lithium ions) in the surface of the plate or particles. For example, when using the lithium cobalt oxide oriented sintered plate as a cathode material for a solid lithium secondary battery, it is possible to enable high capacity and high rate characteristics at the same time. The orientation of the lithium cobalt oxide oriented sintered plate is adapted to coincide with a ratio I[003]/I[104] of the diffracted intensity (peak height) of the (003) plane relative to the diffracted intensity (peak height) of the (104) plane in an XRD profile obtained by irradiating the surface of the sintered plate with X rays. A ratio I[003]/I[104] value of near to 1.6 denotes a non-oriented state, and when the ratio I[003]/I[104] value takes a smaller value (for example, no more than 1.2), the (104) plane is oriented in parallel to the plate surface of the oriented sintered plate. The feature of whether or not the ratio of the diffracted intensity is due to the orientation can be determined by whether or not there is a change between a profile in which the sintered plate is pulverized and measured in a pulverized state and a profile when measured in relation to the surface of the sintered plate.

The thickness of the lithium cobalt oxide oriented sintered plate is preferably 5 to 80 micrometer, more preferably 10 to 70 micrometer till more preferably 20 to 60 micrometer, and particularly preferably 20 to 50 micrometer. Furthermore, the size of the lithium cobalt oxide oriented sintered plate is preferably at least 5 mm×5 mm square, more preferably 10 mm×10 mm˜100 mm×100 mm square, and still more preferably 10 mm×10 mm˜50 mm×50 mm square. To express this feature in another manner, the size is preferably at least 25 mm², more preferably at least 100 to 10,000 mm², and still more preferably at least 100 to 2500 mm².

The density of the lithium cobalt oxide oriented sintered plate is preferably at least 80 volume %, more preferably at least 85 volume % and no more than 99.8 volume %, and still more preferably at least 90 volume % and no more than 99.5 volume %. In this context, “density” is a value that is typically calculated by dividing the measured density of the lithium cobalt oxide oriented sintered plate by the theoretical measured density of lithium cobalt oxide (known value). In another calculation method, the “porosity (vol %)” is measured by use of the surface area ratio of pores that are observed in a predetermined region (for example, 50 micrometer vertically and horizontally) when the cross sectional polished surface of the substrate is observed using an SEM (scanning electron microscope), and the density can be calculated by using that measurement value in the formula “100 (vol %)−porosity (vol %)”. When there is complete density, that is to say, there are no pores at all (porosity=0%), the density is 100 vol %. The porosity decreases as the density increases and the plate surface is prevented from becoming rough. Therefore, when the density of the lithium cobalt oxide oriented sintered plate falls within the above numerical range (range of high density), there is reduced porosity, reduced surface roughness and increase battery capacity in comparison with a configuration in which the density falls within a numerical range that is lower than the above numerical range. On the other hand, in a completely dense configuration (density is 100 volume %), there is a tendency for cracks to be produced in an inner portion of the cathode plate as a result of expansion and shrinkage of the cathode plate during charge and discharge, and therefore there is an adverse effect on cycle characteristics.

Either before or after the lithium cobalt oxide oriented sintered plate preparation step S103 discussed above (step S103 in FIG. 2), a step may be added to cover the surface of the lithium cobalt oxide oriented sintered plate with the above additional element compounds (a compound including at least one of the above additional elements selected from the group consisting of Ti, Al, and Zr, W, Mg, Nb and Ba). In this case, the step of covering with an additional element compound may be a step that is performed prior to the step S103 and between the step S102 and step S103 in FIG. 2, or a step performed after the step S103.

The addition of the additional element (Mg, Al, Si, Ca, Ti, V, Cr, Fe, Cu, Zn, Ga, Ge, Sr, Y, Zr, Nb, Mo, Ag, Sn, Sb, Te, Ba, Bi, or the like) onto the lithium cobalt oxide oriented sintered plate may be performed in any one step of the four steps being the steps S101 to S103 above and the covering step (typically, the step S101 or step S103).

When using a step of adjusting the surface roughness (the smoothness of the surface) of the surface (solid electrolyte layer-side surface 106a of a cathode plate 106 in FIG. 1) that is formed with a solid electrolyte layer of the lithium cobalt oxide oriented sintered plate (cathode plate), a polishing treatment may be performed by use of sandpaper or a polishing tool followed by a thermal treatment after the polishing treatment. The conditions for the thermal treatment are preferably a temperature of 300 degrees C. to 900 degrees C. for one to 10 hours. The surface roughness of the lithium cobalt oxide oriented sintered plate can be adjusted by omitting the polishing treatment while performing the thermal treatment, or by performing the thermal treatment after depositing a compound that contains the above additional element or the above lithium starting material. Alternatively, the surface roughness of the lithium cobalt oxide oriented sintered plate can be adjusted by immersion of the lithium cobalt oxide oriented sintered plate in a weak acid such as acetic acid or the like to thereby chemically treat the surface. In addition, the surface roughness of the lithium cobalt oxide oriented sintered plate can be adjusted by coating particles of cobalt oxide or lithium cobalt oxide onto a cobalt oxide or lithium cobalt oxide sintered plate and then thermally treating. As required, a treatment other than the above treatments may be used as a processing operation to adjust the surface roughness of the lithium cobalt oxide oriented sintered plate.

The above embodiment enables final adjustment of the surface roughness of the cathode plate on which the solid electrolyte layer is formed to a desired set range by adjusting the surface roughness of at least one of the Co₃O₄ oriented sintered plate obtained in the step S102 and the lithium cobalt oxide oriented sintered plate obtained in the step S103. When the surface roughness of the cathode plate falls below 0.1 micrometer, there is a tendency for the solid electrolyte layer to peel away from the cathode plate as a result of volume expansion or volume shrinkage of the cathode plate during charge or discharge operations and the cycle characteristics are adversely affected. When the surface roughness of the cathode plate exceeds 0.7 micrometer, there is a tendency for the production of a localized electrical field concentration in uneven portions during charge-discharge cycle testing. Therefore the production of localized electrical field concentrations can be suppressed and peeling as described above can be prevented by adjustment of the surface roughness of the cathode plate to a range of 0.1 micrometer to 0.7 micrometer. As a result, an all-solid lithium battery that in particular exhibits superior cycle characteristics can be provided by adjusting the surface roughness of the cathode plate. The surface roughness of the cathode plate is configured by use of a calculated average roughness Ra that is obtained based on the method disclosed in JIS0601-2001. More specifically, the surface roughness (calculated average roughness) Ra of the cathode plate can be obtained by averaging three measurement results obtained as a result of scanning a 0.15 mm range by use of a 3D laser microscope (OLS4100 manufactured by Olympus Corporation) at three different positions on the cathode plate.

In the present embodiment, although there is disclosure that surface roughness is one parameter that defines the surface unevenness of the cathode plate, another parameter that defines the surface unevenness structure (for example, specific surface area) may be used as required in addition to surface roughness.

In the present embodiment, after adjusting the surface roughness of the cathode plate to the above set range, it is further preferred to adjust the thickness of the solid electrolyte layer to a range from 1.0 micrometer to 6.0 micrometer. In this manner, since the film stress can be adjusted in response to the film formation conditions of the solid electrolyte layer, localized shorting can be reduced by peeling of the solid electrolyte layer. Therefore, construction of an all-solid battery that exhibits particularly superior performance both in relation to cycle characteristics and rate characteristics is enabled by forming a solid electrolyte layer having a thickness that is adjusted to a range of 1.0 micrometer to 6.0 micrometer to a cathode plate having a surface roughness that is adjusted to a range from 0.1 micrometer to 0.7 micrometer.

In the present embodiment, after adjusting the surface roughness of the cathode plate to the above set range, it is preferred to adjust the thickness of the solid electrolyte layer to a range from 0.5 micrometer to 3.0 micrometer. When the thickness of the solid electrolyte layer is adjusted to at least 0.5 micrometer, the occurrence of defects in the solid electrolyte layer can be suppressed. When the thickness of the solid electrolyte layer is adjusted to no more than 3.0 micrometer, peeling of the solid electrolyte layer can be suppressed, and an increase in the resistance of the solid electrolyte layer itself can be suppressed to thereby enhance rate characteristics. Therefore the rate characteristics can be enhanced even when there is a limitation on the thickness of the solid electrolyte layer similar to a configuration when there is an intention to suppress the resistance of the solid electrolyte layer itself. As a result, an all-solid battery that, in particular, is superior both in relation to cycle characteristics and rate characteristics can be provided.

### EXAMPLES

Aspects and the operation and results of the present invention will be clarified with reference to the embodiments described below. For the sake of convenience, the following description has omitted disclosure of the inventors who are the actors that execute respective processing operations and treatments.

### (1) Preparation of Lithium Cobalt Oxide (LiCoO₂) Oriented Sintered Plate

Five lithium cobalt oxide oriented sintered plates were prepared using the following procedures as examples and comparative examples.

### (1a) Preparation of Green Sheet

A mixed powder was obtained by adding Bi₂O₃ (standard volume D50 particle diameter 0.3 micrometer manufactured by Taiyo KoKo Co., Ltd.) in a 10 wt % ratio into Co₃O₄ starting material powder (standard volume D50 particle diameter 0.3 micrometer manufactured by Seido Chemical Industry Co., Ltd.). Next, a mixture was obtained by mixing 10 parts by weight of the mixed powder above, 100 parts by weight of a dispersion medium (toluene:isopropanol=1:1), 10 parts by weight of a binder (polyvinyl butylal: Product No. BM-2 manufactured by Sekisui Chemical Co., Ltd.), 4 parts by weight of a plasticizer (DOP:Di (2-ethylhexyl)phthalate manufactured by Kurogane Kasei Co., Ltd.), and 2 parts by weight of a dispersant (Product Name Rheodol SP-030 manufactured by Kao Corporation). The mixture was degassed by stirring under a reduced pressure and the viscosity of the mixture was adjusted to 4000 cP. The viscosity during preparation was measured using an LUT viscometer manufactured by Brookfield). A green sheet was obtained by forming the slurry prepared in the above manner into a sheet-shaped configuration by use of a doctor blade method onto a PET film to thereby achieve a thickness after drying of 24 micrometer.

(1b) Preparation of Co₃O₄ Oriented Sintered Plate

The green sheet was peeled from the PET film and cut using a cutter to have 50 mm sides, placed in the center of a zirconia setter (dimensions of 90 mm sides, height 1 mm) to execute an embossing process with a projection dimension of 300 micrometer. Then after firing for 5 hours at 1300 degrees C., the temperature was reduced at a temperature reduction rate of 50 degrees C./hour and a Co₃O₄ oriented sintered plate was removed as the portion that was not attached to the setter.

(1c) Introduction of Lithium into Co₃O₄ Oriented Sintered Plate

Lithium hydroxide in the form of LiOH.H₂O powder (produced by Wako Pure Chemical Industries Ltd.) was pulverized to no more than 1 micrometer by use of a jet mill to prepare a slurry dispersed in ethanol. The slurry was coated in a configuration of Li/Co=1.3 onto a Co₃O₄ oriented sintered plate and dried. Then, thermal treatment for 10 hours at a temperature of 840 degrees C. in an atmosphere of air was performed to obtain a lithium cobalt oxide oriented sintered plate. The five respective lithium cobalt oxide oriented sintered plates were polished using five types of polishing members having a grain size of from #1000 to #150, and then thermal treatment was performed for five hours at 500 degrees C. to prepare five types of lithium cobalt oxide oriented sintered plate having a different surface roughness (surface roughness: 0.05 micrometer, 0.1 micrometer, 0.4 micrometer, 0.7 micrometer, and 1.2 micrometer).

### (2) Evaluation

The five types of lithium cobalt oxide oriented sintered plates prepared above were evaluated in the following manner.

### (2a) Confirmation of Orientation by XRD Measurement

XRD (X-ray diffraction) measurement was performed to confirm that the (104) plane of the plurality of crystal planes of LiCoO₂ on each lithium cobalt oxide oriented sintered plate has a parallel orientation. This measurement used an XRD device (Geigerflex RAD-IB manufactured by Rigaku Corporation) to measure an XRD profile when X rays are irradiated onto a surface of a sintered plate. The ratio of I[003]/I[104] which is the ratio of the diffracted intensity (peak height) of the (003) plane relative to the diffracted intensity (peak height) of the (104) plane was calculated from the measured XRD profile, and the ratio of I[003]/I[104] was found to be 0.3. On the other hand, after each lithium cobalt oxide oriented sintered plate set forth above was fully grind to a fine powder in a mortar, a powder XRD profile was measured, and the ratio of I[003]/I[104] was found to be 1.6. This result indicates that many of the (104) planes of LiCoO₂ were parallel to the plate surface, that is to say, it is confirmed that there is a desired orientation suitable for a high capacity lithium secondary battery.

### (2b) Surface Roughness

A 3D laser microscope (OLS4100 manufactured by Olympus Corporation) was used to measure the surface roughness of each lithium cobalt oxide oriented sintered plate with a scanning range of 0.15 mm and thereby calculate a surface roughness Ra with reference to the method dated in JIS0601-2001. In this case, the surface roughness at three different positions on the surface of each sintered plate was measured and an average value of the three measurement results was taken to the surface roughness (calculated average roughness) Ra.

### (2c) Density

The outer dimensions of each lithium cobalt oxide oriented sintered plate were measured using an optical microscope, and the measured dimensions were used to calculate the volume of the resulting sintered plate. The weight of each lithium cobalt oxide oriented sintered plate was measured using an electronic scales. The density was calculated by dividing the weight by the volume, and a value obtained by dividing the calculated density by the theoretical density of lithium cobalt oxide (known value) was calculated as the density of each lithium cobalt oxide oriented sintered plate.

### (2d) Preparation and Evaluation of Battery

### (i) Preparation of Cathode

A cathode is prepared by fixing each lithium cobalt oxide oriented sintered plate (cathode plate) to a stainless current collection plate (cathode-side current collector) by use of an epoxy-based conductive adhesive containing a dispersion of conductive carbon.

### (ii) Preparation of Solid Electrolyte Layer

A lithium phosphate sintered body target having a diameter of 4 inches (about 10 cm) is prepared. The target is used in a sputtering operation that uses a sputtering device (SPF-430H manufactured by Canon/Anelva Corporation) to form a film thickness (thickness) of 2 micrometer under conditions of an output of 0.2 kW and a pressure of 0.2 Pa for N₂ that is a gas used when using an RF magnetron configuration. In this manner, an LiPON-based solid electrolyte sputter film having a film thickness of 2 micrometer is formed on the cathode plate. Then cross-sectional SEM observation after chemical polishing (CP polishing) of the surface of the solid electrolyte layer is performed to confirm the actual film thickness of the solid electrolyte layer.

(iii) Preparation of all-Solid Lithium Battery

Sputtering was performed by an ion sputtering device (JFC-1500 manufactured by JEOL Ltd.) to form an Au film of 500 Å (Angstroms) thickness on the solid electrolyte layer. In a glovebox with an Ar atmosphere, an Li metal foil, and a current collector configured by a Cu foil were disposed on the resulting Au film, and pressure bonded using a hotplate at 200 degrees C. In this manner, single cells configured as cathode plate/solid electrolyte layer/anode layer (size: 10×10 mm²) were obtained. Therefore, five types of all-solid lithium batteries A to E exhibiting a different surface roughness Ra of the lithium cobalt oxide oriented sintered plate (cathode plate) were obtained by sealing the resulting single cells with an external covering material formed from an Al laminate film in an Ar atmosphere (reference is made to Table 1).

### (iv) Battery Evaluation

The respective all-solid lithium batteries A to E were charged to 4.2 V using an 0.1 mA constant current and then charged with a constant voltage so that the current becomes 0.05 mA. Then, the 0.05 mA constant current was discharged until 2.5V and the resulting service capacity was taken to be W0. This operation was repeated 10 times for each all-solid lithium battery, and the service capacity at that time was taken to be W10. Division of the service capacity W10 by the service capacity W0 (=W10/W0)×100) gives a capacity retention (%).

TABLE 1

| | Cathode Plate Surface | Capacity |
|---|---|---|
| All-solid Lithium Battery | Roughness (Micrometer) | Retention (%) |
| A (Comparative Example 1) | 0.05 | 60 |
| B (Example 1) | 0.1 | 98 |
| C (Example 2) | 0.4 | 98 |
| D (Example 3) | 0.7 | 99 |
| E (Comparative Example 2) | 1.2 | short |

### Evaluation

As shown in Table 1, when the all-solid lithium battery A (Comparative Example 1) was used, the capacity retention was reduced by 60% as a result of peeling of the solid electrolyte layer from the surface of the cathode plate (interface with the solid electrolyte layer). In this case, there was a tendency for peeling of the solid electrolyte layer from the cathode plate as a result of volume expansion or volume shrinkage of the cathode plate during charge and discharge that had an adverse effect on cycle characteristics. Furthermore when using the all-solid lithium battery E (Comparative Example 2), shorting resulted from the generation of localized concentration of electrical fields in the uneven portion of the surface of the cathode plate during charge-discharge cycle testing. In this manner, when the surface roughness of the cathode plate falls below 0.1 micrometer or exceeds 0.7 micrometer, the inventors cannot obtain an all-solid lithium battery having the desired high performance. In contrast, when any of the all-solid lithium batteries B to D (Examples 1 to 3) were used, it was confirmed that peeling of the solid electrolyte layer from the surface of the cathode plate did not occur and the retention capacity was maintained to a high level of at least 98%. Therefore, it is confirmed that a high-performance all-solid lithium battery exhibiting a low reduction in capacity can be provided by adjusting the surface roughness Ra of the cathode plate to the range of 0.1 micrometer to 0.7 micrometer.

1. A cathode plate of an all-solid battery that configures a cathode of an all-solid battery including a solid electrolyte layer composed of an oxide-based ceramic material, wherein
a surface roughness on a solid electrolyte layer-side surface of the cathode plate on which the solid electrolyte layer is formed falls within a range of 0.1 micrometer to 0.7 micrometer.

2. The cathode plate of an all-solid battery according to claim 1, wherein
a thickness of the solid electrolyte layer formed on the solid electrolyte layer-side surface of the cathode plate is in a range from 0.5 micrometer to 3.0 micrometer.

3. The cathode plate of an all-solid battery according to claim 1, wherein
a thickness is in a range from 10 micrometer to 60 micrometer

4. The cathode plate of an all-solid battery according to claim 1 further comprising lithium cobalt oxide, wherein
the solid electrolyte layer is composed of a lithium phosphorus oxynitride-based ceramic material that is an oxide-based ceramic material.

5. An all-solid battery comprising:
a cathode plate, and
a solid electrolyte layer formed on the surface of the cathode plate, wherein
the cathode plate is the cathode plate of an all-solid battery according to claim 1.
